(19) United States
(12) Patent Application Publication
(10) Pub. No.: US 2002/0065750 A1
(43) Pub. Date: May 30, 2002

(54) Order-acceptance management apparatus and method

(76) Inventor: Hideki Tanaka, Tokyo (JP)

Correspondence Address: ROBIN BLECKER & DALEY, 2ND FLOOR, 330 MADISON AVENUE, NEW YORK, NY, 10017, US

(21) Appl. No.: 09/991,620

(22) Filed: Nov. 5, 2001

(30) Foreign Application Priority Data
Nov. 27, 2000 (JP) 360208/2000

(51) Int. Cl. G06F 17/60

(52) U.S. Cl. 705/28

(57) ABSTRACT

Order-acceptance management capable of supplying commodities to customers in accordance with the customers is executed. The invention assigns a rank to an orderer and implements acceptance of an order for a commodity in accordance with the rank. The number of units of a commodity in stock is allocated to a group corresponding to the rank. When an order is issued, it is determined whether the order can be accepted. This determination entails determining whether the commodity that belongs to the group corresponding to the rank assigned to the orderer and that is capable of satisfying the order issued is in stock. If the commodity ordered issued is in stock, it is determined that the issued order is capable of being accepted.

### FIELD OF THE INVENTION

This invention relates to art concerning management for the acceptance of orders.

### BACKGROUND OF THE INVENTION

How to manage the inventory of commodities and the acceptance of orders for commodities is extremely important to achieve a balance between market demand and production volume. Generally, in order to prevent excess inventory, production volume is decided in accordance with market demand so as to avoid overproduction. This means that cases can arise in which demand for a commodity temporarily exceeds production volume. Consequently, a situation can arise in which some customers can be supplied with the commodity while others cannot.

In such cases it is not infrequent for a sales manager to decide on his or her own which customer should be supplied with the commodity. The sales manager's own customers or acquaintances are likely to be supplied while customers not on such good terms with the manager are not.

When the decision as to which customers should be supplied with a commodity is left solely to the discretion of the sales manager, however, the criteria used differ from one time to another and customers are not treated fairly. This is undesirable. In addition, making the decision takes time and the procedure involved tends to be a complicated one. On the other hand, there are also instances where the manager wishes to supply preferred customers with a commodity on a priority basis.

### SUMMARY OF THE INVENTION

Accordingly, an object of the present invention is to supply commodities appropriately in accordance with each of a number of customers.

According to the present invention, there is provided an order-acceptance management apparatus for assigning a rank to an orderer and implementing acceptance of an order for a commodity in accordance with the rank, comprising:

inventory acquisition means for acquiring information concerning number of units of a commodity in stock from storage means in which number of units of the commodity in stock has been stored upon being allocated to a group corresponding to the rank; and

determination means for determining whether an order can be accepted if the order has been issued;

wherein said determination means determines, on the basis of the information concerning the number of units in stock acquired by said inventory acquisition means, whether the commodity that belongs to the group corresponding to the rank assigned to the orderer and that is capable of satisfying the order issued is in stock, and determines that the issued order is capable of being accepted if it is determined that the commodity is in stock.

According to the present invention, there is also provided an order-acceptance management method for assigning a rank to an orderer and implementing acceptance of an order for a commodity in accordance with the rank, comprising:

an inventory acquisition step of acquiring information concerning number of units of a commodity in stock from storage means in which number of units of the commodity in stock has been stored upon being allocated to a group corresponding to the rank; and

a determination step of determining whether an order can be accepted if the order has been issued;

wherein said determination step determines, on the basis of the information concerning the number of units in stock acquired at said inventory acquisition step, whether the commodity that belongs to the group corresponding to the rank assigned to the orderer and that is capable of satisfying the order issued is in stock, and determines that the issued order is capable of being accepted if it is determined that the commodity is in stock.

According to the present invention, there is also provided a storage medium on which has been recorded a program for causing a computer to function as the following means in order to assign a rank to an orderer and implement acceptance of an order for a commodity in accordance with the rank:

inventory acquisition means for acquiring information concerning number of units of a commodity in stock from storage means in which number of units of the commodity in stock has been stored upon being allocated to a group corresponding to the rank; and

determination means for determining whether an order can be accepted if the order has been issued;

wherein said determination means determines, on the basis of the information concerning the number of units in stock acquired by said inventory acquisition means, whether the commodity that belongs to the group corresponding to the rank assigned to the orderer and that is capable of satisfying the order issued is in stock, and determines that the issued order is capable of being accepted if it is determined that the commodity is in stock.

According to the present invention, there is also provided a program for causing a computer to function as the following means in order to assign a rank to an orderer and implement acceptance of an order for a commodity in accordance with the rank:

inventory acquisition means for acquiring information concerning number of units of a commodity in stock from storage means in which number of units of the commodity in stock has been stored upon being allocated to a group corresponding to the rank; and

determination means for determining whether an order can be accepted if the order has been issued;

wherein said determination means determines, on the basis of the information concerning the number of units in stock acquired by said inventory acquisition means, whether the commodity that belongs to the group corresponding to the rank assigned to the orderer and that is capable of satisfying the order issued is in stock, and determines that the issued order is capable of being accepted if it is determined that the commodity is in stock.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate an embodiment of the invention and, together with the description, serve to explain the principles of the invention.

FIG. 1 is a system diagram illustrating an overview of a system for accepting an order for a commodity utilizing an order-acceptance management apparatus according to an embodiment of the present invention;

FIG. 2 is a block diagram of the order-acceptance management apparatus;

FIG. 3 is a diagram showing an example of customer data;

FIG. 4 is a diagram showing an example of inventory management data;

FIG. 5 is a diagram showing an example of shipment data;

FIG. 6 is a diagram showing an example of delivery data;

FIG. 7 is a flowchart illustrating processing for deciding allocation ratio;

FIG. 8 is a flowchart illustrating processing for updating inventory management data;

FIG. 9 is a diagram showing an example of a GUI for when issuance of an order is requested;

FIG. 10 is a flowchart illustrating processing for accepting an order; and

FIG. 11 is a diagram illustrating an example of a display notifying of acceptance of an order presented on the display screen of a computer or the like.

### DESCRIPTION OF THE PREFERRED EMBODIMENT

A preferred embodiment of the present invention will now be described in detail in accordance with the accompanying drawings.

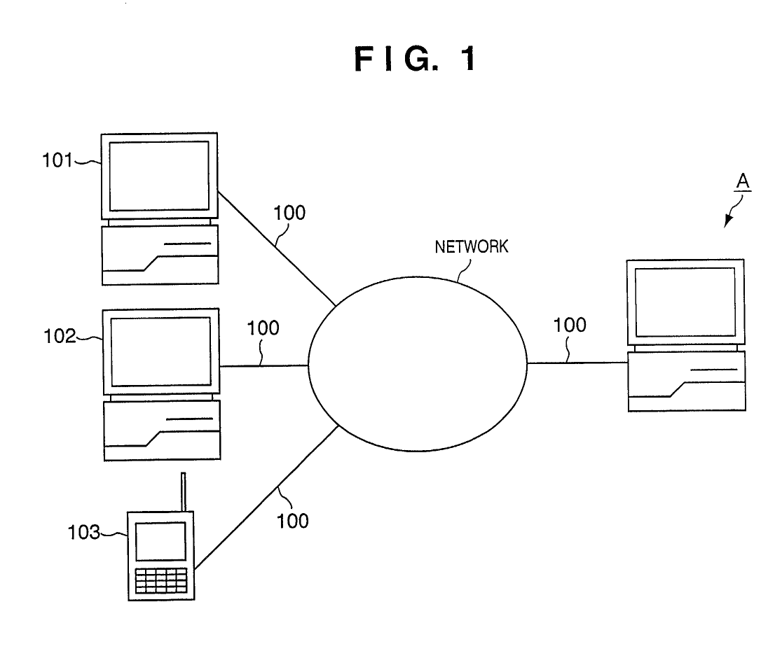

FIG. 1 is a system diagram illustrating an overview of a system for accepting an order for a commodity utilizing an order-acceptance management apparatus A according to an embodiment of the present invention.

The system comprises the order-acceptance management apparatus A, computers 101, 102 and a portable terminal 103 that are connected to the order-acceptance management apparatus A by being connected to a network such as the Internet via wired or wireless communication channels 100.

The computers 101, 102 and portable terminal 103 are terminals utilized by customers in order to place orders for commodities. This embodiment envisages a case where an order is placed by accessing the website of a company that uses the order-acceptance management apparatus A. It goes without saying that an order can be placed by other means as well, such as by e-mail, telephone or facsimile machine.

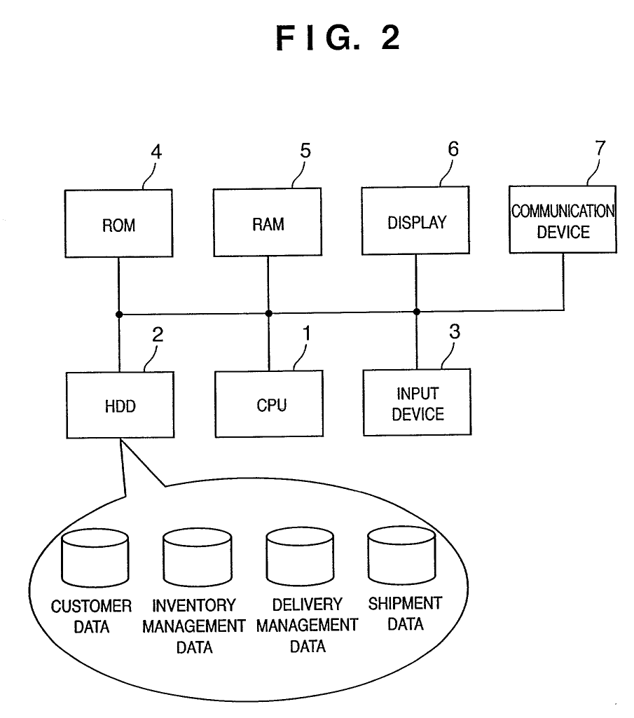

FIG. 2 is a block diagram of the order-acceptance management apparatus A.

As shown in FIG. 2, the order-acceptance management apparatus A is implemented by a general-purpose computer having a communication capability and basically includes a CPU 1 for exercising overall control of the order-acceptance management apparatus A and executing order-acceptance management processing according to this embodiment; a hard-disk drive (HDD) 2; an input device 3 such as a mouse or keyboard; a ROM 4 in which a program and the like for order-acceptance management has been stored; a display 6 such as a CRT for displaying the content of processing; and a communication device 7 such as a modem connected to the network.

Customer data, inventory management data, delivery management data and shipping data utilized in order-acceptance management processing according to this embodiment have been stored on the hard disk of the hard-disk drive 2. Naturally, these items of data do not necessarily have to be stored on the hard disk. For example, the data can be stored in a computer or server communicably connected to the order-acceptance management apparatus A so that the data can be utilized whenever the order-acceptance management apparatus A requires. The order-acceptance management apparatus of the present invention covers such a configuration as well.

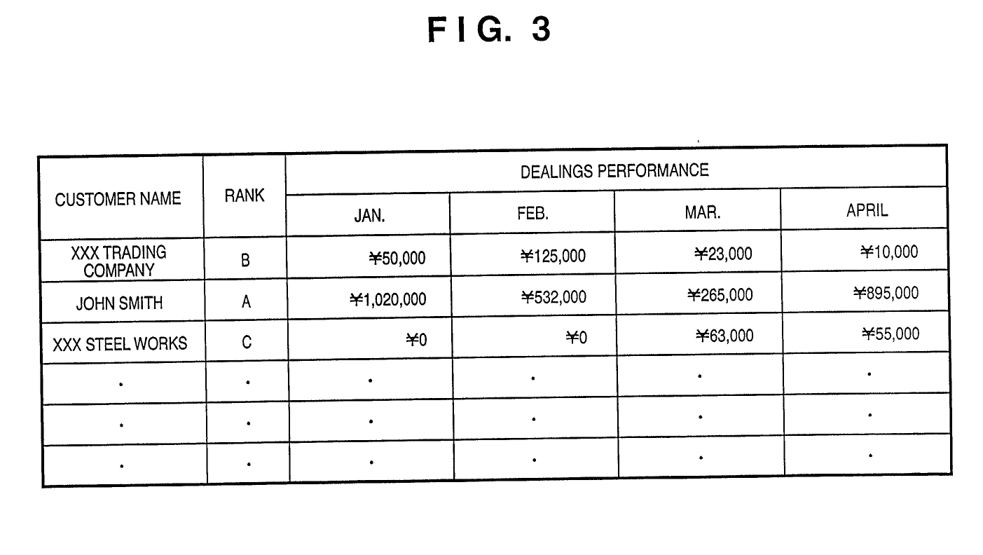

FIG. 3 is a diagram showing an example of the customer data. The customer data has the form of a table in which rank and dealings performance are indicated on a per-customer basis. Rank is decided based upon the degree of importance of the customer. In this embodiment, three ranks of levels A, B and C are adopted. The ranks have the priority A>B>C, in which B and C are ranked lower than A and C is ranked below B. The rank of each customer can be decided in accordance with past dealings performance recorded in the customer data, by way of example. In this embodiment, commodities are supplied also to lower ranking customers while commodities are supplied to higher ranking customers to the extent possible, as will be described later.

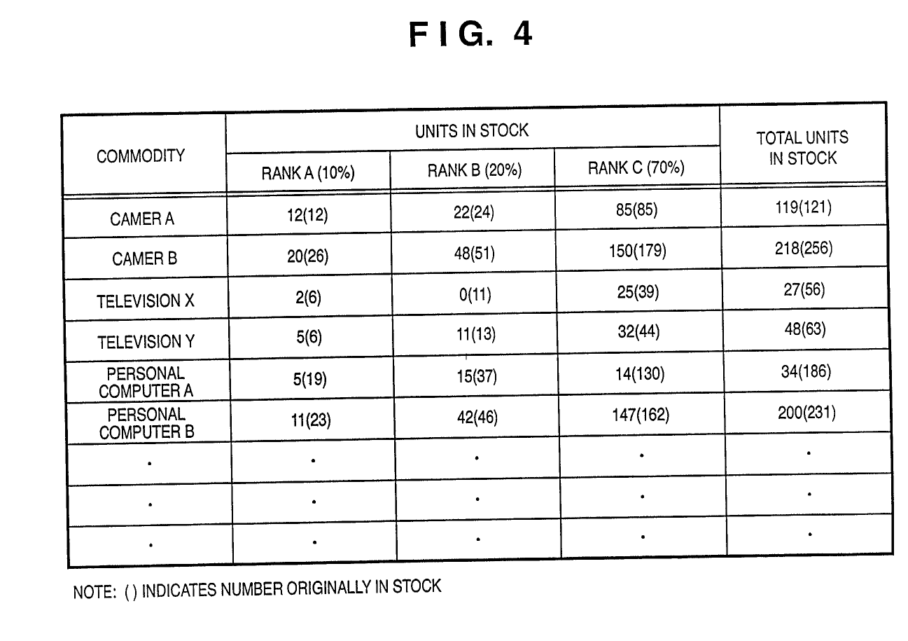

FIG. 4 shows an example of the inventory management data. The inventory management data has the form of a table in which the number of units in stock is indicated on a per-commodity basis. In particular, according to this embodiment, the numbers of units in stock are managed by allocating a number to each group corresponding to the customer rank described above. For example, the inventory of the commodity that is Camera A is allocated as follows: 12 units to the group corresponding to rank A, 22 units to the group corresponding to rank B and 85 units to the group corresponding to rank C. The total number of units of this commodity in stock is 119.

In this embodiment, this allocation of units to each group can be performed when a commodity is accepted from the manufacturing department. The figures within the parentheses in FIG. 4 indicate, for reference purposes, the quantity that was in stock when the commodity was received from the manufacturing department. With regard to the commodity that is Camera A, FIG. 4 indicates that there were 121 units originally, that 12, i.e., approximately 10%, of these were allocated to the group corresponding to rank A, that 24, i.e., approximately 20%, of these were allocated to the group corresponding to rank B, and that 85, i.e., approximately 70%, of these were allocated to the group corresponding to rank C.

In a case where inventory of a commodity exists when the commodity is received from the manufacturing department, the number obtained by adding the total number of units of the commodity in stock to the total number of units of the commodity accepted from the manufacturing department may be allocated to each of the groups in accordance with the above-described procedure, or only the total number of units of the commodity accepted from the manufacturing department may be allocated to each of the groups in accordance with the above-described procedure.

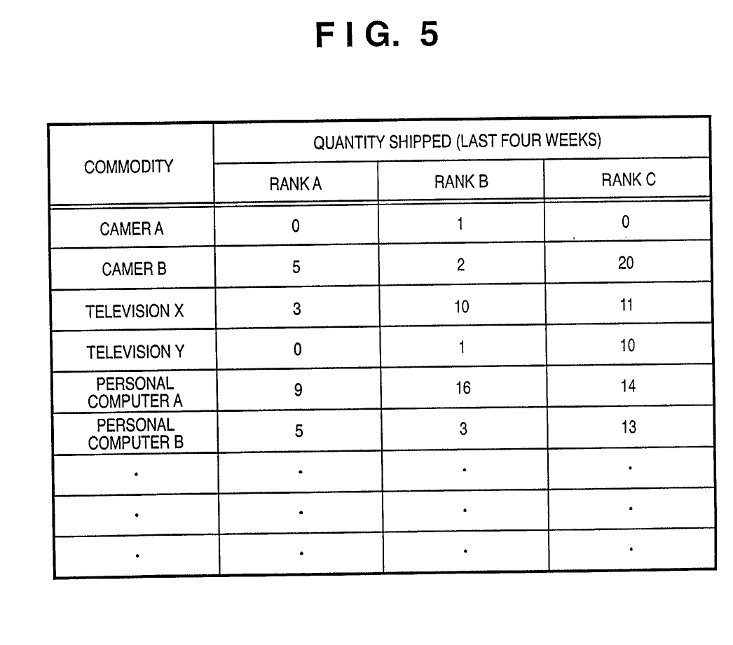

In the example of FIG. 4, the allocation ratio for each group is the same for all commodities. However, the ratios may be different from one commodity to another. It is preferred that the ratio be decided in dependence upon the needs of the customer of each rank. In this embodiment, therefore, shipping data in which is recorded the quantity of a commodity shipped in the past four weeks for each rank has been stored on the hard-disk drive 2. The allocation ratio is decided upon referring to this shipping data periodically. FIG. 5 is a diagram showing an example of such shipping data. Here the quantities shipped in the past four weeks on a per-rank basis are recorded of a per-commodity basis. For example, in FIG. 5, the number of units of Camera B shipped under rank C was comparatively large and the number shipped under rank B was comparatively small. Accordingly, when the allocation ratio is decided the next time, the ratio for rank C can be raised and that for rank B can be lowered.

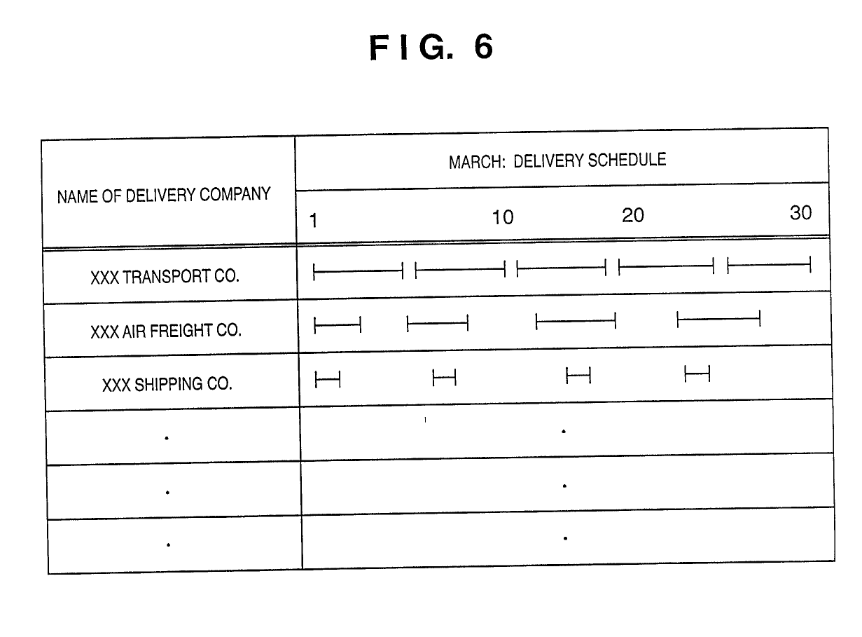

The delivery management data will be described next. FIG. 6 is a diagram showing an example of the delivery management data. This data indicates a delivery schedule for each delivery company. The delivery date of a commodity for which an order has been placed can be decided by referring to this data.

Processing executed by the order-acceptance management apparatus A constructed as set forth above will be described next.

<Processing For Deciding Allocation Ratio>

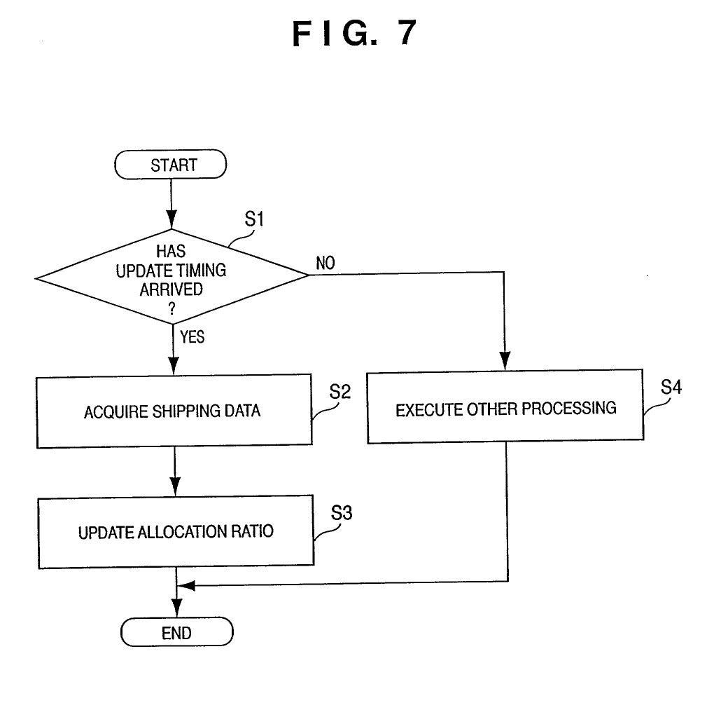

Described next will be processing for deciding the allocation ratio of number of units in stock in each group in the inventory management data set forth above. FIG. 7 is a flowchart illustrating the processing for deciding allocation ratio.

It is decided at step S1 in FIG. 7 whether update timing has arrived. By way example, updating can be carried out every few weeks or every few months. If the timing for updating has arrived, control proceeds to step S2; otherwise, control proceeds to step S4 and other processing is executed.

The CPU 1 acquires the shipping data, which is exemplified in FIG. 5, from the hard-disk drive 2 at step S2 and checks the quantities shipped under each of the ranks A to C. Next, at step S3, the allocation ratio of each rank is decided based upon the shipping data acquired. For example, the total number of units of Camera B shipped in FIG. 5 is 27, and the numbers of units shipped under ranks A, B and C are 5, 2 and 20, respectively. Accordingly, it can be determined that the ratios for ranks A, B and C are 20%, 10% and 70%, respectively. This processing is then exited.

<Processing For Updating Inventory Management Data>

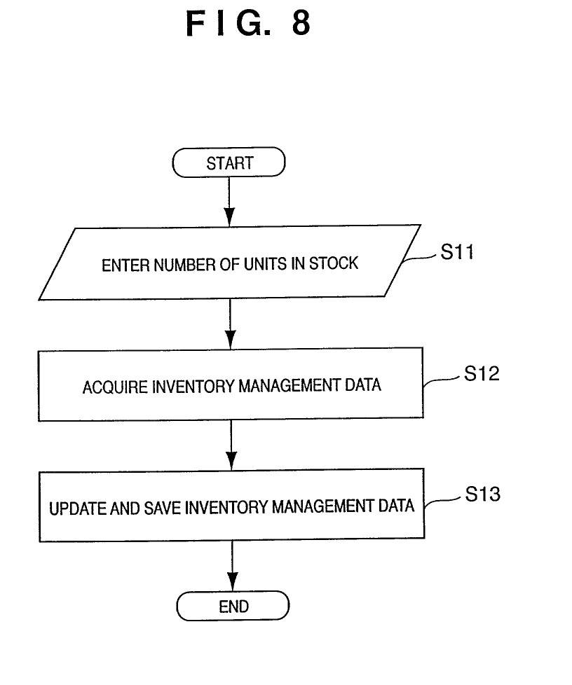

Processing for updating the data representing the number of units in stock in a case where a commodity has been newly received from the manufacturing department will now be described. FIG. 8 is a flowchart illustrating processing for updating the inventory management data.

After a commodity of interest has been specified, step S11 in FIG. 8 calls for the entry of the number of units of the commodity that has been newly received from the manufacturing department, i.e., the new number of units in stock, to the order-acceptance management apparatus A. For example, the operator enters the number from the input device 3.

Next, at step S12, the CPU 1 acquires the inventory management data by reading this data out of the hard-disk drive 2. This is followed by step S13, at which the entered number of units in stock is allocated in accordance with the allocation ratio of each rank and is added to the group of each rank regarding the commodity, thereby updating the inventory management data. The inventory management data after updating is saved on the hard disk of the hard-disk drive 2. This processing is then exited.

<Order-acceptance Processing>

Described next will be processing executed by the order-acceptance management apparatus A in a case where a customer orders a commodity utilizing the computer 101 or 102 or the portable terminal 103 shown in FIG. 1.

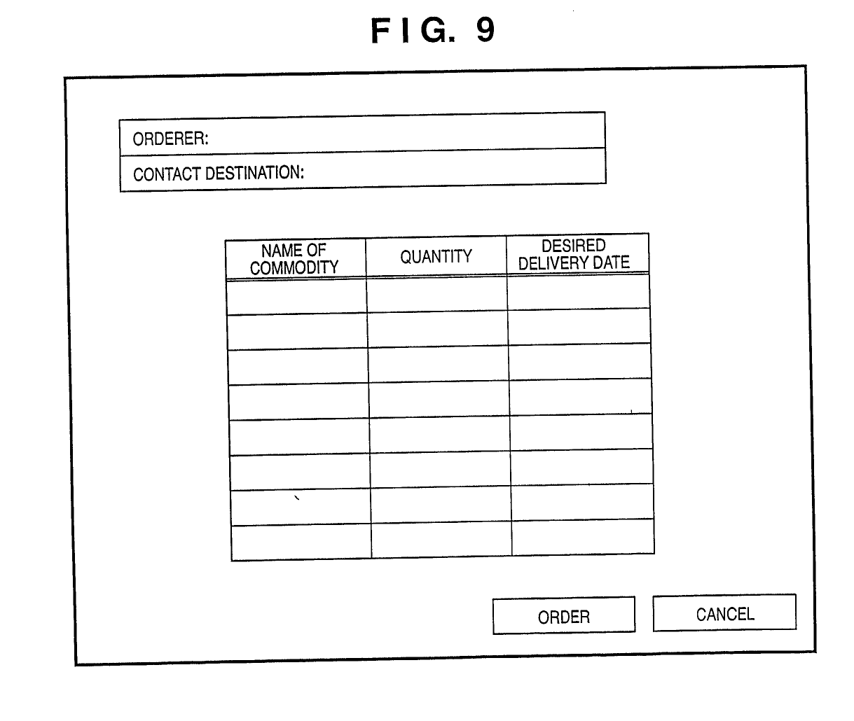

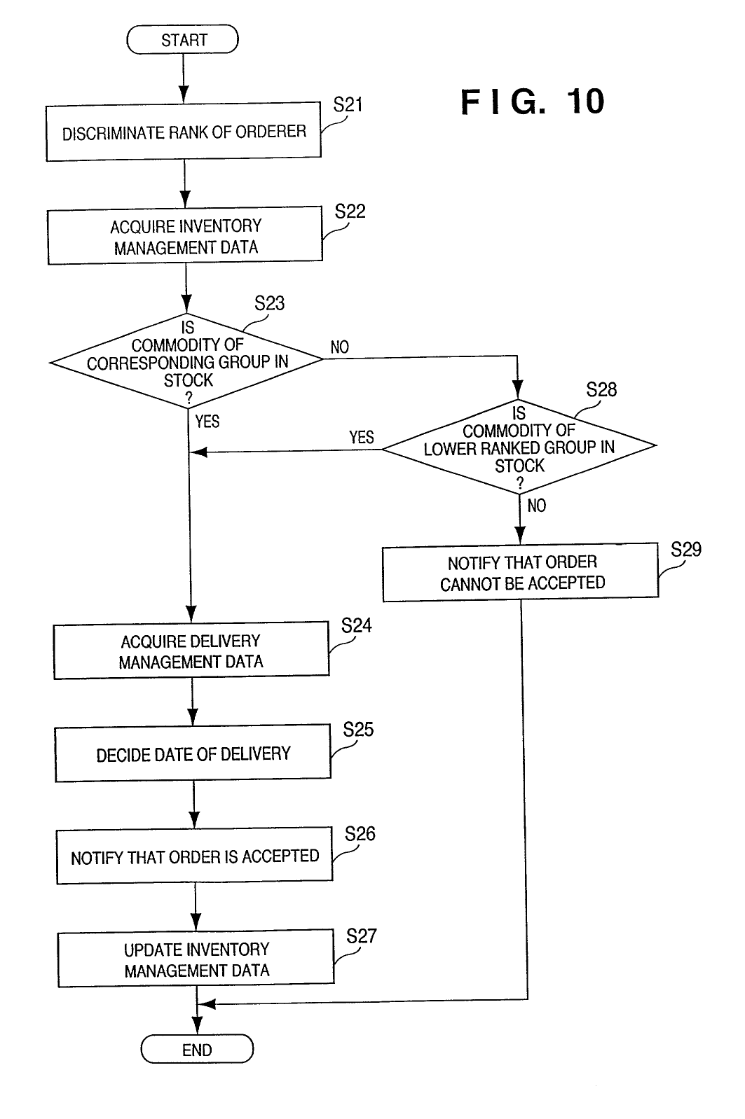

First, the customer accesses the order-acceptance management apparatus A as by the computer 101 and instructs the apparatus of a request to place an order. In response, a GUI (Graphical User Interface) of the kind shown in FIG. 9 is displayed on, e.g., the computer 101 of the customer. The customer then enters the necessary particulars in “ORDERER” and “CONTACT DESTINATION” fields in order to identify himself, enters the name of the commodity to be ordered, the quantity thereof and the desired delivery date in “COMMODITY NAME”, “QUANTITY” and “DESIRED DELIVERY DATE” fields, respectively, and presses and “ORDER” button. When this is done, the entered information is transmitted to the order-acceptance management apparatus A, which then proceeds to execute order-acceptance processing, described below. FIG. 10 is a flowchart illustrating the order-acceptance processing.

The rank that has been assigned to the orderer is discriminated at step S21. Specifically, the CPU 1 acquires the customer data from the hard-disk drive 2, compares the customer data with the orderer name transmitted from the computer 101 and determines the rank of the orderer. In a case where the orderer is a new orderer whose name has not been recorded in the order data, a predetermined rank can be applied unconditionally. In this embodiment, rank is discriminated based upon the rank recorded in the customer data. However, an arrangement may be adopted in which ranking is performed based upon whether the desired delivery date is soon or not, irrespective of whether a rank has been recorded in the customer data.

The CPU 1 acquires the inventory management data from the hard-disk drive 2 at step S22. Next, at step S23, it is determined whether the ordered quantity of a commodity is greater than the number of units in the inventory of the group corresponding to the rank of the orderer. If the ordered quantity is greater than the inventory (“NO” at step S23), it is judged that the order cannot be accepted and control proceeds to step S28. If the ordered quantity is equal to or less than the inventory (“YES” at step S23), it is judged that the order can be accepted and control proceeds to step S24.

Assume by way of example that the rank of the orderer is rank A, that the commodity ordered is Camera A, and that the quantity ordered is 13. In accordance with the inventory management data of FIG. 4, the inventory for Camera A in the group corresponding to rank A is 12 units and, therefore, the order cannot be accepted. On the other hand, if the rank of the orderer is rank B, the inventory for Camera A in the group corresponding to rank B is 22 units and, therefore, it is judged that the order can be accepted. Thus, even if an order can be accepted on the grounds of the total number of units in inventory, it is decided that the order cannot be accepted if the number of units in the inventory of the group of the particular rank is inadequate.

Step S28 calls for a determination as to whether the ordered volume of the commodity is greater than the number of units in the inventory of a group corresponding to a rank lower than that assigned to the ordered. The reason for this is to treat a high-ranked orderer preferentially and supply this orderer with the commodity in an amount above the quota of the group so that the commodity will reach this orderer to the greatest extent possible.

For example, assume that the rank of the orderer is rank A, that the commodity ordered is Camera A, and that the quantity ordered is 13. In accordance with the inventory management data of FIG. 4, the inventory for Camera A in the group corresponding to rank A is 12 units and, therefore, the order cannot be accepted at first (“NO” at step S23). However, since the inventory for Camera A in the group corresponding to rank B, which is lower than rank A, is 22 units, it is judged that the order can be accepted. If the quantity ordered is greater than the inventory for the group corresponding to rank B in this case, then a further decision can be rendered with regard to the number of units in the inventory for the group corresponding to rank C, which is the lowermost rank.

If it is thus decided at step S28 that the quantity ordered is greater than the number of units in inventories of the lower ranks (“NO” at step S28), it is judged that the order cannot be accepted and control proceeds to step S29. If it is decided that the quantity ordered is equal to or less than the number of units in inventories of the lower ranks (“YES” at step S28), it is judged that the order can be accepted and control proceeds to step S24. It goes without saying that an arrangement may be adopted in which a higher ranking customer is not given special consideration, so that when it is determined at step S23 that an order cannot be accepted, the processing of step S28 is skipped and control proceeds directly to step S29.

The CPU 1 acquires the delivery management data from the hard-disk drive 2 at step S24. Next, at step S25, the delivery date of the ordered commodity is decided based upon the delivery management data acquired.

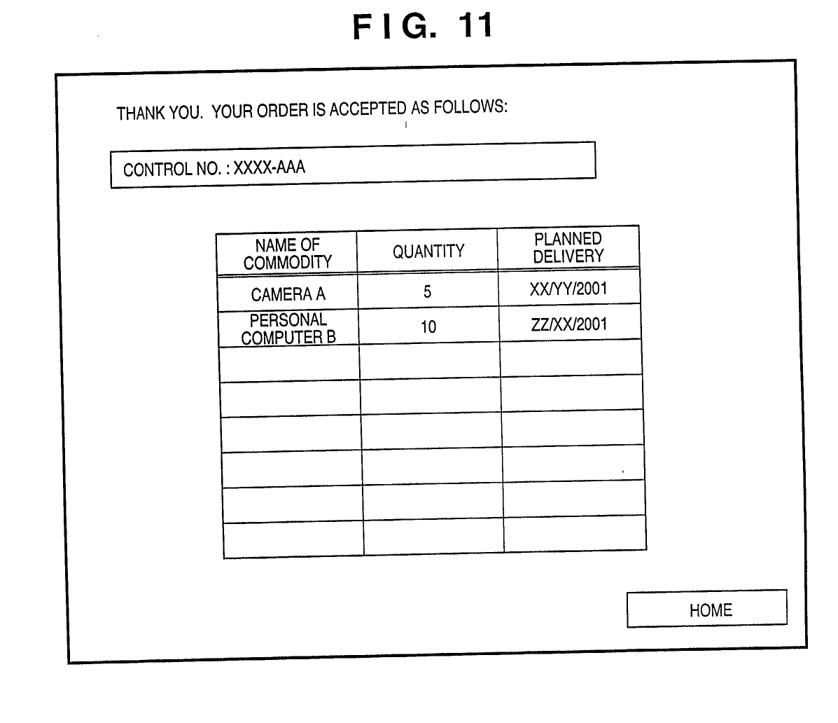

The computer 101 of the orderer is notified at step S26 of the fact that the order has been accepted. FIG. 11 is a diagram illustrating an example of a display notifying of acceptance of an order presented on the display screen of the computer 101. The displayed notification of acceptance of the order includes a “CONTROL NUMBER”, the name and the quantity of the commodity ordered, and the delivery date (planned delivery) decided at step S25. It is possible to adopt an arrangement in which when the delivery date decided at step S25 does not satisfy that desired by the orderer, this fact is displayed in the notification and the orderer is allowed to confirm whether this delivery date is acceptable. The method of notifying that the order has been accepted can be another method, such as e-mail, telephone or facsimile.

At step S29, on the other hand, the computer 101 of the orderer is notified that the order cannot be accepted. This can be achieved by displaying the fact on the display of the computer 101 in a form similar to that illustrated in FIG. 11.

Next, the inventory management data is updated at step S27 and saved on the hard disk of the hard-disk drive 2. More specifically, the ordered quantity of the commodity for which the order has been accepted is subtracted from the number of units of the commodity in stock. For example, if the rank of the orderer is rank A and the number of units of Camera A ordered is ten in the inventory management data of FIG. 4, the number of units in the stock of the group corresponding to rank A is updated from 12 to 2. Further, if the rank of the orderer is rank A and an order for 13 units of Camera A has been accepted through the processing of step S28, then the number of units in the inventory of the group corresponding to rank B is updated from 22 to 9. This ends order-acceptance processing.

Thus, in accordance with this embodiment, acceptance of an order for a commodity is performed in accordance with a rank assigned to the orderer. This makes it possible to eliminate unfair treatment of customers and eliminates the need for a sales manager to make the sales decision. As a result, processing can be executed smoothly and rapidly. In addition, whether an order can be accepted or not can be reported to the orderer substantially in real time.

Furthermore, by providing the processing of step S28 described above, special treatment can be given to a preferred customer while unfair treatment of customers is eliminated. This makes it possible to supply commodities appropriately in accordance with each customer.

It goes without saying that the object of the invention is attained also by supplying a storage medium (or recording medium) storing the program codes of the software for performing the functions of the foregoing embodiment to a system or an apparatus, reading the program codes with a computer (e.g., a CPU or MPU) of the system or apparatus from the storage medium, and then executing the program codes. In this case, the program codes read from the storage medium implement the novel functions of the embodiment and the storage medium storing the program codes constitutes the invention. Furthermore, besides the case where the aforesaid functions according to the embodiment are implemented by executing the program codes read by a computer, it goes without saying that the present invention covers a case where an operating system or the like running on the computer performs a part of or the entire process in accordance with the designation of program codes and implements the functions according to the embodiment.

It goes without saying that the present invention further covers a case where, after the program codes read from the storage medium are written in a function expansion card inserted into the computer or in a memory provided in a function expansion unit connected to the computer, a CPU or the like contained in the function expansion card or function expansion unit performs a part of or the entire process in accordance with the designation of program codes and implements the function of the above embodiment.

As many apparently widely different embodiments of the present invention can be made without departing from the spirit and scope thereof, it is to be understood that the invention is not limited to the specific embodiments thereof except as defined in the appended claims.

What is claimed is:

1. An order-acceptance management apparatus for assigning a rank to an orderer and implementing acceptance of an order for a commodity in accordance with the rank, comprising:
inventory acquisition means for acquiring information concerning number of units of a commodity in stock from storage means in which number of units of the commodity in stock has been stored upon being allocated to a group corresponding to the rank; and
determination means for determining whether an order can be accepted if the order has been issued;
wherein said determination means determines, on the basis of the information concerning the number of units in stock acquired by said inventory acquisition means, whether the commodity that belongs to the group corresponding to the rank assigned to the orderer and that is capable of satisfying the order issued is in stock, and determines that the issued order is capable of being accepted if it is determined that the commodity is in stock.

2. The apparatus according to claim 1, wherein if said determination means determines that the commodity that belongs to the group corresponding to the rank assigned to the orderer is not in stock, then said determination means determines whether the commodity that belongs to a group corresponding to a rank lower than the first-mentioned rank is in stock; and if said determination means determines that the commodity is in stock, then said determination means determines that the issued order is capable of being accepted.

3. The apparatus according to claim 1, further comprising allocation decision means for deciding allocation of number of units of the commodity in stock on a per-group basis.

4. The apparatus according to claim 3, further comprising dealings-performance acquisition means for acquiring information concerning dealings performance from storage means in which dealings performance on a per-rank basis has been stored;
wherein said allocation decision means decides the allocation based upon the information concerning dealings performance acquired by said dealings-performance acquisition means.

5. The apparatus according to claim 1, further comprising:
delivery-schedule acquisition means for acquiring information concerning a delivery schedule of a commodity from storage means in which the delivery schedule has been stored; and
means for deciding a delivery date of a commodity for which an order has been accepted based upon the information concerning the delivery schedule acquired by said delivery-schedule acquisition means.

6. The apparatus according to claim 1, wherein said apparatus is connected via a communication channel to a computer that issues the order.

7. The apparatus according to claim 6, further comprising means for notifying the computer of whether the issued order will be accepted or not based upon the determination made by said determination means.

8. The apparatus according to claim 6, further comprising:
delivery-schedule acquisition means for acquiring information concerning a delivery schedule of a commodity from storage means in which the delivery schedule has been stored;
means for deciding a delivery date of a commodity for which an order has been accepted based upon the information concerning the delivery schedule acquired by said delivery-schedule acquisition means; and
means for notifying the computer of the delivery date that has been decided.

9. The apparatus according to claim 1, wherein a computer connected to said apparatus is provided with the storage means.

10. An order-acceptance management method for assigning a rank to an orderer and implementing acceptance of an order for a commodity in accordance with the rank, comprising:
an inventory acquisition step of acquiring information concerning number of units of a commodity in stock from storage means in which number of units of the commodity in stock has been stored upon being allocated to a group corresponding to the rank; and
a determination step of determining whether an order can be accepted if the order has been issued;
wherein said determination step determines, on the basis of the information concerning the number of units in stock acquired at said inventory acquisition step, whether the commodity that belongs to the group corresponding to the rank assigned to the orderer and that is capable of satisfying the order issued is in stock, and determines that the issued order is capable of being accepted if it is determined that the commodity is in stock.

11. The method according to claim 10, wherein if said determination step determines that the commodity that belongs to the group corresponding to the rank assigned to the orderer is not in stock, then said determination step determines whether the commodity that belongs to a group corresponding to a rank lower than the first-mentioned rank is in stock; and if said determination step determines that the commodity is in stock, then said determination step determines that the issued order is capable of being accepted.

12. The method according to claim 10, further comprising an allocation decision step of deciding allocation of number of units of the commodity in stock on a per-group basis.

13. The method according to claim 12, further comprising a dealings-performance acquisition step of acquiring information concerning dealings performance from storage means in which dealings performance on a per-rank basis has been stored;
wherein said allocation decision step decides the allocation based upon the information concerning dealings performance acquired at said dealings-performance acquisition step.

14. The method according to claim 10, further comprising:
a delivery-schedule acquisition step of acquiring information concerning a delivery schedule of a commodity from storage means in which the delivery schedule has been stored; and
a step of deciding a delivery date of a commodity for which an order has been accepted based upon the information concerning the delivery schedule acquired at said delivery-schedule acquisition step.

15. A storage medium on which has been recorded a program for causing a computer to function as the following means in order to assign a rank to an orderer and implement acceptance of an order for a commodity in accordance with the rank:
inventory acquisition means for acquiring information concerning number of units of a commodity in stock from storage means in which number of units of the commodity in stock has been stored upon being allocated to a group corresponding to the rank; and
determination means for determining whether an order can be accepted if the order has been issued;
wherein said determination means determines, on the basis of the information concerning the number of units in stock acquired by said inventory acquisition means, whether the commodity that belongs to the group corresponding to the rank assigned to the orderer and that is capable of satisfying the order issued is in stock, and determines that the issued order is capable of being accepted if it is determined that the commodity is in stock.

16. The storage medium according to claim 15, wherein if said determination means determines that the commodity that belongs to the group corresponding to the rank assigned to the orderer is not in stock, then said determination means determines whether the commodity that belongs to a group corresponding to a rank lower than the first-mentioned rank is in stock; and if said determination means determines that the commodity is in stock, then said determination means determines that the issued order is capable of being accepted.

17. The storage medium according to claim 15, wherein said program includes a program for causing the computer to function as allocation decision means for deciding allocation of number of units of the commodity in stock on a per-group basis.

18. The storage medium according to claim 17, wherein said program includes a program for causing the computer to function as dealings-performance acquisition means for acquiring information concerning dealings performance from storage means in which dealings performance on a per-rank basis has been stored;
wherein said allocation decision means decides the allocation based upon the information concerning dealings performance acquired by said dealings-performance acquisition means.

19. The storage medium according to claim 15, wherein said program includes a program for causing the computer to function as:
delivery-schedule acquisition means for acquiring information concerning a delivery schedule of a commodity from storage means in which the delivery schedule has been stored; and
means for deciding a delivery date of a commodity for which an order has been accepted based upon the information concerning the delivery schedule acquired by said delivery-schedule acquisition means.

20. A program for causing a computer to function as the following means in order to assign a rank to an orderer and implement acceptance of an order for a commodity in accordance with the rank:
inventory acquisition means for acquiring information concerning number of units of a commodity in stock from storage means in which number of units of the commodity in stock has been stored upon being allocated to a group corresponding to the rank; and
determination means for determining whether an order can be accepted if the order has been issued;
wherein said determination means determines, on the basis of the information concerning the number of units in stock acquired by said inventory acquisition means, whether the commodity that belongs to the group corresponding to the rank assigned to the orderer and that is capable of satisfying the order issued is in stock, and determines that the issued order is capable of being accepted if it is determined that the commodity is in stock.
